(19) United States
(12) Patent Application Publication
(10) Pub. No.: US 2025/0039745 A1
(43) Pub. Date: Jan. 30, 2025

(54) COMMUNICATION METHOD, ACCESS NETWORK NODE, USER EQUIPMENT

(71) Applicant: NEC CORPORATION, Minato-ku, Tokyo (JP)

(72) Inventors: Zhe CHEN, Tokyo (JP); Neeraj Gupta, Tokyo (JP)

(73) Assignee: NEC CORPORATION, Minato-ku, Tokyo (JP)

(21) Appl. No.: 18/716,214

(22) PCT Filed: Dec. 6, 2022
(86) PCT No.: PCT/JP2022/045000

§ 371 Date: Jun. 4, 2024

(30) Foreign Application Priority Data
Dec. 24, 2021 (GB) 2119032.7

(51) Int. Cl. H04W 36/00; H04L 5/00; H04W 36/38; H04W 76/20

(52) U.S. Cl. CPC H04W 36/0007; H04L 5/0053; H04W 36/385; H04W 76/20

(57) ABSTRACT

A communication system(1) is disclosed in which a first access network node (base station) receives information indicating whether a second access network node supports Multicast and Broadcast Services (MBS). Interaction such as handover between the first access network node and the second access network node is controlled based on the information.

A communication system(1) is disclosed in which a first access network node (base station) receives information indicating whether a second access network node supports Multicast and Broadcast Services (MBS). Interaction such as handover between the first access network node and the second access network node is controlled based on the information.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to control plane for multimedia broadcast services in the so-called ‘5G’ (or ‘Next Generation’) systems.

### BACKGROUND ART

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present application will use the term base station to refer to any such base stations.

For simplicity, the present application will use the term mobile device, user device, or UE to refer to any communication device that is able to connect to the core network via one or more base stations. Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

One of the recent features being developed over the existing 5G framework is referred to as Multicast and Broadcast Services (MBS). This functionality aims to enhance 5G New Radio and 5G Core Network capabilities for a reliable, low latency, resource efficient, and massive deployment of a wide array of multicast and broadcast services. 3GPP is currently specifying the details of MBS for media distribution over mobile broadband networks. MBS (or ‘NR MBS’ in 5G) aims to reuse cellular infrastructure such as the so-called Low Power Low Tower (LPLT) infrastructure. One of the main use cases is the delivery of linear/live media content to smartphones, tablets, vehicles, and other mobile (or stationary) devices. Although MBS is designed to use existing (or already specified) 3GPP infrastructure, it can provide a more efficient delivery of multicast/broadcast traffic than unicast communication using the same infrastructure. Details of architectural enhancements for MBS may be found in the in 3GPP Technical Specification (TS) 23.247 V17.0.0, the contents of which are incorporated herein by reference.

3GPP is discussing UE mobility between MBS supporting and non-supporting nodes. In the non-supporting MBS node, the base station (gNB) has a unicast context for the UE as opposed to a multicast context in the MBS supporting node. More specifically, MBS aims to use multicast (over shared user plane tunnels) for delivering MBS traffic to multiple UEs in the same MBS session, whenever possible. This is because multicast is more efficient than unicast when the same data needs to be delivered to multiple users. The methods for delivering MBS session data may be referred to as ‘individual MBS traffic delivery method’ in case of unicast and ‘shared MBS traffic delivery method’ in case of multicast.

During mobility procedures such as handover, the UE context is shared in the handover signalling between the source base station (gNB) and target base station (gNB). However, base stations that support MBS hold different data in the UE context than base station that do not support MBS, due to the different delivery method used, which may lead to data loss when performing handover between different types of base stations and/or poor user experience. Such data loss may be caused for example the different types of bearers used for multicast and unicast.

When a UE joins an MBS session, a shared user plane tunnel is established for that session between the serving base station and a user plane function in the core network for delivery of MBS traffic. The base station can decide whether to use a point-to-point (PTP) or a point-to-multipoint (PTM) tunnel/bearer. A shared user plane tunnel (NG-U/F1-U tunnel) is used for PTM. A multicast radio bearer (MRB) is used for the MBS session. An MRB may be provided on a PTP leg, a PTM leg, or both. In case of a PTP leg, a shared user plane tunnel may be configured although this is not yet specified by 3GPP.

### SUMMARY OF INVENTION

### Technical Problem

The inventors have realised that when a UE performs handover from an MBS supporting node to a MBS non-supporting node, the MRB should be converted to a DRB (and vice versa). Although the target NG-RAN node can indicate to the core network (in a Path Switch Request message) whether it supports MBS currently it is not possible to signal this support capability to the source base station. Thus, the source base station is not aware whether the target base station is a MBS supporting node or not which may result in inefficiency and data loss.

Moreover, legacy handover signalling does not support UE handover from an MBS supporting node to a MBS non-supporting node which may result in handover failure (in which case the UE may need to establish a new connection at a suitable base station).

Accordingly, the present invention seeks to provide methods and associated apparatus that address or at least alleviate (at least some of) the above-described issues.

### Solution to Problem

In one aspect, the invention provides a method performed by a first access network node, the method comprising: receiving information (‘MBS support information’) indicating whether a second access network node supports Multicast and Broadcast Services (MBS); and controlling interaction between the first access network node and the second access network node based on the information.

In one aspect, the invention provides a method performed by a first access network node, the method comprising: transmitting, to a second access network node, information indicating whether the first access network node supports Multicast and Broadcast Services (MBS), wherein in a case that the first access network node supports MBS, the information includes information identifying at least one service area, MBS service information, and information identifying a delivery mode; and controlling interaction between the first access network node and the second access network node based on the information.

In one aspect, the invention provides a method performed by a user equipment (UE), the method comprising: transmitting, to an access network node, information indicating whether a cell supports Multicast and Broadcast Services (MBS); and controlling communications between the UE and the cell based on the information.

In one aspect, the invention provides a method performed by a first access network node acting as a source node for handover of a user equipment (UE) communicating using a multicast radio bearer (MRB) via the first access network node, the method comprising: reconfiguring the UE to use a first data radio bearer (DRB) at the first access network node for Multicast and Broadcast Services (MBS) in a case that a second access network acting as a target node for the handover does not support MBS over MRB; and performing a procedure for handover of the UE to the second access network node whereby an MBS service is provided to the UE over a second DRB at the second access network node.

In one aspect, the invention provides a method performed by a first access network node acting as a source node for handover of a user equipment (UE) communicating using a multicast radio bearer (MRB) via the first access network node, the method comprising: initiating a procedure for handover of the UE to a second access network node; and in a case that the second access network acting as a target node for the handover does not support Multicast and Broadcast Services (MBS) over MRB, reconfiguring the UE to use a first data radio bearer (DRB) at the second access network node, whereby an MBS service is provided to the UE over the first DRB.

In one aspect, the invention provides a method performed by a first access network node acting as a target node for handover of a user equipment (UE) communicating using a multicast radio bearer (MRB) via a second access network node, the method comprising: receiving, from the second access network node acting as a source node for the handover, a message including configuration information for a data radio bearer (DRB) to be used by the UE for a Multicast and Broadcast Services (MBS) service at the first access network node; performing handover for the UE including establishing the DRB at the first access network node based on the configuration information; and providing the MBS service to the UE over the DRB at the first access network node.

In one aspect, the invention provides a method performed by a user equipment (UE) receiving a Multicast and Broadcast Services (MBS) service using a multicast radio bearer (MRB) via a first access network node, the method comprising: receiving, from the first access network node acting as a source node for a handover, a message for reconfiguring the UE to use a first data radio bearer (DRB) at the first access network node for the MBS service in a case that a second access network node acting as a target node for the handover does not support MBS over MRB; performing handover by reconfiguring from the first DRB to a second DRB at the second access network node; and receiving the MBS service over the second DRB.

In one aspect, the invention provides a method performed by a user equipment (UE) receiving a Multicast and Broadcast Services (MBS) service using a multicast radio bearer (MRB) via a first access network node, the method comprising: receiving, from the first access network node acting as a source node for a handover, a message for reconfiguring the UE to use a data radio bearer (DRB) at a second access network node acting as a target node for the handover, in a case that the second access network does not support MBS over MRB; performing handover from the MRB to the DRB; and receiving the MBS service over the DRB.

In one aspect, the invention provides a method performed by a network node for handling connection and mobility management for a user equipment (UE), the method comprising: receiving, from a first access network node acting as a target node for handover of the UE, a request for switching a path from a second access network node acting as a source node to the first access network node, the request including information identifying at least one Multicast and Broadcast Services (MBS) service supported by the first access network node and information identifying at least one associated MBS service area; and transmitting, to the first access network node, a message acknowledging the path switch request, wherein, in a case that a first MBS service is provided to the UE via the second access network node using an individual MBS traffic delivery method (e.g. unicast), the message is adapted to include information for providing the first MBS service to the UE, via the first access network node, using a shared MBS traffic delivery method (e.g. multicast/broadcast), when it is determined that the first MBS service is supported by the first access network node in an associated MBS service area.

In one aspect, the invention provides a method performed by a first access network node acting as a target node for handover of a user equipment (UE), the method comprising: transmitting, to a network node for handling connection and mobility management for the UE, a request for switching a path from a second access network node acting as a source node to the first access network node, the request including information identifying at least one Multicast and Broadcast Services (MBS) service supported by the first access network node and information identifying at least one associated MBS service area; and receiving, from the network node, a message acknowledging the path switch request, wherein, in a case that a first MBS service is provided to the UE via the second access network node using an individual MBS traffic delivery method (e.g. unicast), the message is adapted to include information for providing the first MBS service to the UE, via the first access network node, using a shared MBS traffic delivery method (e.g. multicast/broadcast), when the first MBS service is supported by the first access network node in an associated MBS service area.

In one aspect, the invention provides a first access network node comprising: means (for example a memory, a transceiver, and a processor) for receiving information indicating whether a second access network node supports Multicast and Broadcast Services (MBS); and means for controlling interaction between the first access network node and the second access network node based on the information.

In one aspect, the invention provides a first access network node comprising: means (for example a memory, a transceiver, and a processor) for transmitting, to a second access network node, information indicating whether the first access network node supports Multicast and Broadcast Services (MBS), wherein in a case that the first access network node supports MBS, the information includes information identifying at least one service area, MBS service information, and information identifying a delivery mode; and means for controlling interaction between the first access network node and the second access network node based on the information.

In one aspect, the invention provides a user equipment (UE) comprising: means (for example a memory, a transceiver, and a processor) for transmitting, to an access network node, information indicating whether a cell supports Multicast and Broadcast Services (MBS); and means for controlling communications between the UE and the cell based on the information.

In one aspect, the invention provides a first access network node acting as a source node for handover of a user equipment (UE) communicating using a multicast radio bearer (MRB) via the first access network node, the first access network node comprising: means (for example a memory, a transceiver, and a processor) for reconfiguring the UE to use a first data radio bearer (DRB) at the first access network node for Multicast and Broadcast Services (MBS) in a case that a second access network acting as a target node for the handover does not support MBS over MRB; and means for performing a procedure for handover of the UE to the second access network node whereby an MBS service is provided to the UE over a second DRB at the second access network node.

In one aspect, the invention provides a first access network node acting as a source node for handover of a user equipment (UE) communicating using a multicast radio bearer (MRB) via the first access network node, the first access network node comprising: means (for example a memory, a transceiver, and a processor) for initiating a procedure for handover of the UE to a second access network node; and means for reconfiguring the UE, in a case that the second access network acting as a target node for the handover does not support Multicast and Broadcast Services (MBS) over MRB, to use a first data radio bearer (DRB) at the second access network node, whereby an MBS service is provided to the UE over the first DRB.

In one aspect, the invention provides a first access network node acting as a target node for handover of a user equipment (UE) communicating using a multicast radio bearer (MRB) via a second access network node, the first access network node comprising: means (for example a memory, a transceiver, and a processor) for receiving, from the second access network node acting as a source node for the handover, a message including configuration information for a data radio bearer (DRB) to be used by the UE for a Multicast and Broadcast Services (MBS) service at the first access network node; means for performing handover for the UE including establishing the DRB at the first access network node based on the configuration information; and means for providing the MBS service to the UE over the DRB at the first access network node.

In one aspect, the invention provides a user equipment (UE) receiving a Multicast and Broadcast Services (MBS) service using a multicast radio bearer (MRB) via a first access network node, the UE comprising: means (for example a memory, a transceiver, and a processor) for receiving, from the first access network node acting as a source node for a handover, a message for reconfiguring the UE to use a first data radio bearer (DRB) at the first access network node for the MBS service in a case that a second access network node acting as a target node for the handover does not support MBS over MRB; means for performing handover by reconfiguring from the first DRB to a second DRB at the second access network node; and means for receiving the MBS service over the second DRB.

In one aspect, the invention provides a user equipment (UE) receiving a Multicast and Broadcast Services (MBS) service using a multicast radio bearer (MRB) via a first access network node, the UE comprising: means (for example a memory, a transceiver, and a processor) for receiving, from the first access network node acting as a source node for a handover, a message for reconfiguring the UE to use a data radio bearer (DRB) at a second access network node acting as a target node for the handover, in a case that the second access network does not support MBS over MRB; means for performing handover from the MRB to the DRB; and means for receiving the MBS service over the DRB.

In one aspect, the invention provides a network node for handling connection and mobility management for a user equipment (UE), the network node comprising: means (for example a memory, a transceiver, and a processor) for receiving, from a first access network node acting as a target node for handover of the UE, a request for switching a path from a second access network node acting as a source node to the first access network node, the request including information identifying at least one Multicast and Broadcast Services (MBS) service supported by the first access network node and information identifying at least one associated MBS service area; and means for transmitting, to the first access network node, a message acknowledging the path switch request, wherein, in a case that a first MBS service is provided to the UE via the second access network node using an individual MBS traffic delivery method (e.g. unicast), the message is adapted to include information for providing the first MBS service to the UE, via the first access network node, using a shared MBS traffic delivery method (e.g. multicast/broadcast), when it is determined that the first MBS service is supported by the first access network node in an associated MBS service area.

In one aspect, the invention provides a first access network node acting as a target node for handover of a user equipment (UE), the first access network node comprising: means (for example a memory, a transceiver, and a processor) for transmitting, to a network node for handling connection and mobility management for the UE, a request for switching a path from a second access network node acting as a source node to the first access network node, the request including information identifying at least one Multicast and Broadcast Services (MBS) service supported by the first access network node and information identifying at least one associated MBS service area; and means for receiving, from the network node, a message acknowledging the path switch request, wherein, in a case that a first MBS service is provided to the UE via the second access network node using an individual MBS traffic delivery method (e.g. unicast), the message is adapted to include information for providing the first MBS service to the UE, via the first access network node, using a shared MBS traffic delivery method (e.g. multicast/broadcast), when the first MBS service is supported by the first access network node in an associated MBS service area.

Aspects of the invention extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied;

FIG. 2 illustrates schematically a mobile (cellular or wireless) telecommunication system to which embodiments of the invention may be applied;

FIG. 3 is a schematic block diagram of a mobile device forming part of the system shown in FIG. 1;

FIG. 4 is a schematic block diagram of an access network node (e.g. base station) forming part of the system shown in FIG. 1;

FIG. 5 is a schematic block diagram of a core network node (e.g. AMF) forming part of the system shown in FIG. 1; and

FIG. 6 is a schematic signalling (timing) diagram illustrating some exemplary embodiments of the present invention.

FIG. 7 is a schematic signalling (timing) diagram illustrating some exemplary embodiments of the present invention.

FIG. 8 is a schematic signalling (timing) diagram illustrating some exemplary embodiments of the present invention.

FIG. 9 is a schematic signalling (timing) diagram illustrating some exemplary embodiments of the present invention.

FIG. 10 is a schematic signalling (timing) diagram illustrating some exemplary embodiments of the present invention.

FIG. 11 is a schematic signalling (timing) diagram illustrating some exemplary embodiments of the present invention.

### DESCRIPTION OF EMBODIMENTS

### Overview

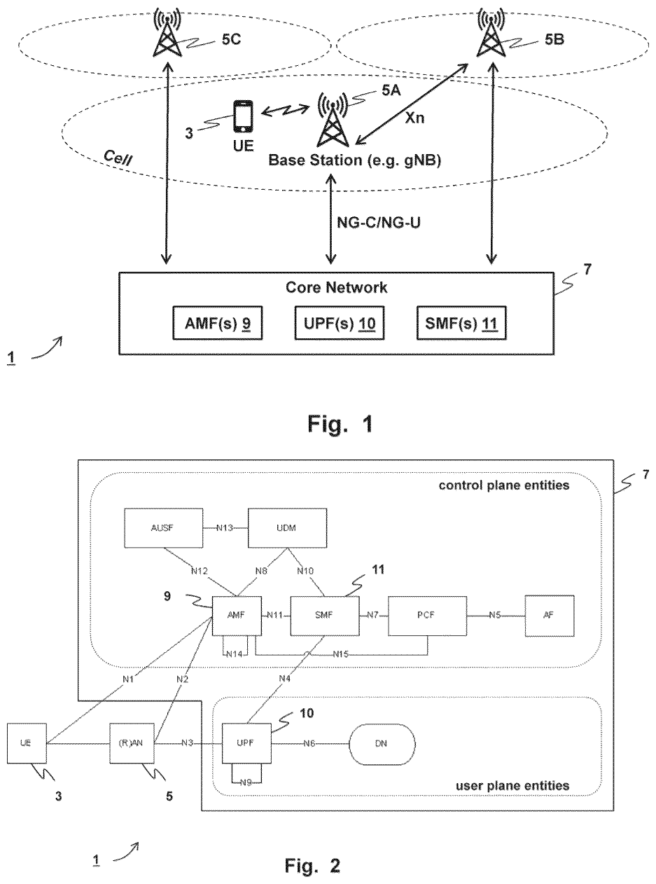

FIGS. 1 and 2 illustrate schematically a mobile (cellular or wireless) telecommunication system 1 to which embodiments of the invention may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and three base stations 5A-5C are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification, and release. In the example shown in FIG. 1, the core network 7 includes one or more AMF(s) 9, one or more UPF(s) 10, and one or more SMF(s) 11. It will be appreciated that the nodes or functions may have different names in different systems.

Further details of the core network 7 are shown in FIG. 2 which also shows the interfaces between respective network nodes. As can be seen, the core network 7 may typically include an Authentication Server Function (AUSF), a Unified Data Management (UDM) entity, a Policy Control Function (PCF), an Application Function (AF), amongst others. The core network 7 is coupled (via the UPF 10) to a Data Network (DN), such as the Internet or a similar Internet Protocol (IP) based network. The core network 7 may also be coupled to an Operations and Maintenance (OAM) function (not shown).

In this system 1, Multicast and Broadcast Services (MBS) functionality is provided to UEs 3 via their serving base station 5 and associated core network nodes such as the UPF 10 and the SMF 11. The UPF 10 may be an MBS specific UPF in which case it may be referred to as the MB-UPF 10M (e.g. dedicated to the provision of MBS functionality). Similarly, the SMF 11 may be an MBS specific SMF in which case it may be referred to as the MB-SMF 11M. However, it will be appreciated that any suitable UPF 10/SMF 11 may be used for MBS.

MBS traffic is distributed using multicast (over shared user plane tunnels), when appropriate, to those UEs that have joined a particular MBS service/session. However, not all base stations 5 (not all cells) support MBS over multicast. Thus, in some cells it may be necessary to provide MBS over unicast.

In the example shown in FIG. 1, the UE's current serving base station 5A provides an MBS session to the UE 3 over unicast. On the other hand, another base station (or another cell), e.g. base station 5B may support the same MBS session over multicast.

In order to facilitate efficient and lossless delivery of MBS to the UE 3, the base stations 5 are configured to obtain information about their neighbours' MBS capabilities. For example, such MBS capability may include whether or not a base station (or a cell thereof) supports MBS, the MBS delivery method supported by that base station (or cell), and a list of MBS services supported by that base station (or cell).

In one option, the base stations 5 are configured to obtain such MBS related information during setting up (or modification) of the connection between neighbouring base stations 5. Connection setup between base stations 5 typically includes an Xn setup procedure (in case of 5G base stations) or an X2 setup procedure (in case of 4G base stations). Connection modification typically includes an Xn or X2 modification procedure.

In another option, the base stations 5 are configured to obtain MBS related information for the other base station during a handover of the UE 3 from one base station 5A (source) to another base station 5B (target). In this case, the source base station 5A may receive information indicating whether the target base station 5B supports MBS (and which services/delivery modes) in a handover request acknowledgement from the target base station 5B. It will be appreciated that the source base station 5A may be configured to indicate its MBS support to the target base station 5B in the handover request sent to the target base station 5B (if not yet indicated during Xn/X2 setup or modification). This information may be useful in case the UE 3 (or another UE) needs to be handed back to the cell of the base station 5A.

In yet another option, the serving base stations 5A may be configured to obtain MBS related information for a neighbour base station 5B from the UE 3, during an Automatic Neighbour Relation (ANR) procedure. For example, the UE 3 may obtain MBS information from a neighbour cell (Cell B) and provide this information to its current serving cell (Cell A). The information obtained may indicate whether the neighbour base station 5B (or neighbour cell) supports MBS (and if it does support MBS, which MBS services and which delivery modes are supported). The information may be included in a ‘CGI-InfoNR’ information element and/or the like.

In this system 1, data loss at handover can be avoided (or at least reduced) by performing the following actions. The (source) base station 5A provides an MBS session via an associated multicast radio bearer (MRB). In one alternative, when performing handover for the UE 3, the (source) base station 5A provides information to the UE for converting the MRB configuration (used for delivering traffic for the MBS session) to an appropriate DRB configuration, and to use a DRB instead of the MRB. In this case, the information may be provided in the form of a mapping table and/or the like that the UE 3 can use to derive and apply the necessary DRB configuration before handover to the target base station 5B. The information may be included in RRC signalling (e.g. RRCReconfiguration).

Once the UE 3 has confirmed that it is using the DRB for the MBS session, the source base station 5A initiates handover to the target base station 5B, using the converted DRB which can be handed over to a corresponding DRB at the target base station 5B without data loss. In another alternative, the source base station 5A converts the MRB configuration to DRB based on the mapping table (without reconfiguring the UE 3 at this phase). In this case, the source base station 5A sends the converted DRB configuration to the target base station 5B in a Handover Request message, and receives the applicable RRC configuration for a target DRB from the target base station 5B (in a Handover Request Acknowledge message). The source base station 5A then sends an appropriately formatted RRCReconfiguration message to the UE 3 (based on the DRB configuration received from the target). The RRCReconfiguration message includes information identifying the mapping between the UE's MRB configuration (currently used at the source) and the associated new DRB configuration to be used at the target base station 5B. Thus, the UE 3 can perform handover from the MRB at the source to a DRB at the target without data loss. It will be appreciated that in some cases it may be necessary to initially convert the MRB to a DRB at the source (similarly to the first alternative), before handing over the UE 3 to the DRB at the target base station 5B.

When performing handover from an access network node (for example base station 5A) that does not support MBS (hence MBS traffic is delivered via unicast) to a node that support MBS via multicast MRB, the UE 3 needs to be configured to use the appropriate MRB at the target (for example base station 5B). The core network nodes need to be aware that the unicast bearer in the non-supporting node 5A is not used anymore and ensure that the UE 3 is handed over to the appropriate MRB at the target base station 5. This is achieved by the target base station 5B sending, to the AMF 9, an appropriately formatted message requesting a path switch and including in the message information identifying at least one MBS service supported by the target base station 5B (e.g. MBS session ID list) and information identifying at least one associated MBS service area (e.g. service area list). The supported MBS services may be provided per service area. Using this information Based on this information, the AMF 3 is able to make a decision whether to establish (or re-use an existing) shared MBS session at the target node 5B. If a shared MBS session is not appropriate, then the AMF can establish a dedicated MBS session at the target node 5B.

Effectively, using the information regarding each other's MBS capability and supported MBS services/service areas (if appropriate), the base stations 5 are able to control interactions with other nodes, including handover related procedures (e.g. perform lossless handover), selecting unicast or multicast tunnels for the UE 3, request the UE 3 to perform RRC reconfiguration in order to change between MRB and DRB delivery method for the MBS service(s) that the UE 3 has joined. The MBS information of a neighbour base station may also be beneficial for a base station that does not support MBS because the information may be used to optimise MBS delivery after handover to a different base station (or cell) that does support MBS. For example, when the UE 3 is handed over to a new cell that supports MBS, the UE 3 can be configured to use a particular shared tunnel (already established) for the MBS session that the UE 3 has joined. The information obtained by a base station may also be shared with a core network node (e.g. AMF or SMF) to control path switching and session management.

### User Equipment (UE)

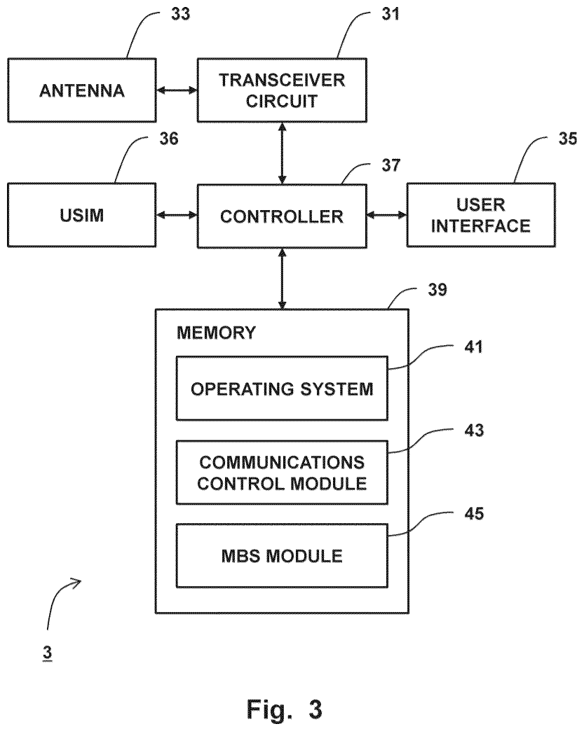

FIG. 3 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43 and an MBS module 45.

The communications control module 43 is responsible for handling (generating/sending/receiving) signalling messages and uplink/downlink data packets between the UE 3 and other nodes, including (R)AN nodes 5 and core network nodes. The signalling may comprise RRC signalling (to/from the (R)AN nodes 5) and/or NG-C/NG-U signalling (to/from the core network 7).

The MBS module 45 is responsible for handling signalling relating to multimedia broadcast services.

### Access Network Node (Base Station)

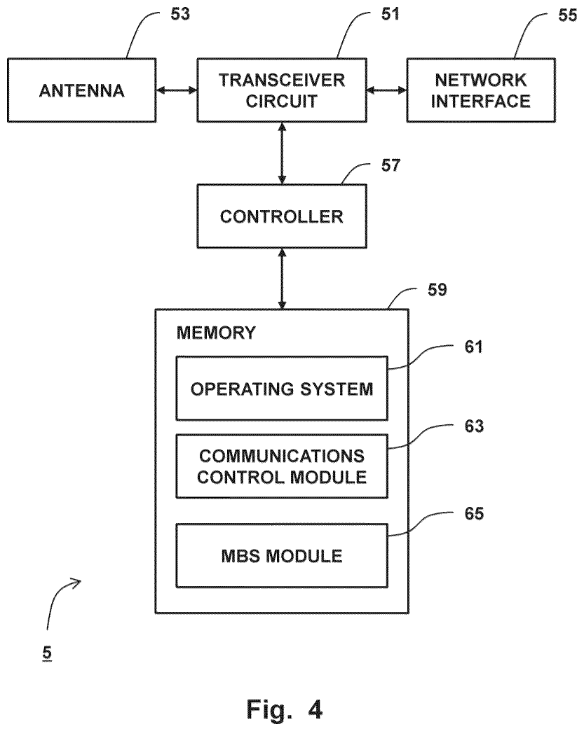

FIG. 4 is a block diagram illustrating the main components of a base station 5 (or a similar access network node) shown in FIG. 1. As shown, the base station 5 has a transceiver circuit 51 for transmitting signals to and for receiving signals from user equipment (such as the mobile device 3) via one or more antenna 53, a network interface 55 for transmitting signals to and for receiving signals from the core network 7 and neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 4, the network interface 55 will also typically include a base station to base station interface portion (e.g. Xn and/or the like), and a core network interface portion (e.g. NG-C/NG-U/N2/N3).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. Non-Access Stratum, Radio Resource Control, system information, paging, and/or the like). It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The RRC sub-module is operable to generate, send and receive signalling messages formatted according to the RRC standard. Such messages are exchanged between the base station 5 and the mobile devices 3 served by that base station 5. The RRC messages may comprise messages relating to handover and/or MBS reconfiguration.

### Core Network Node

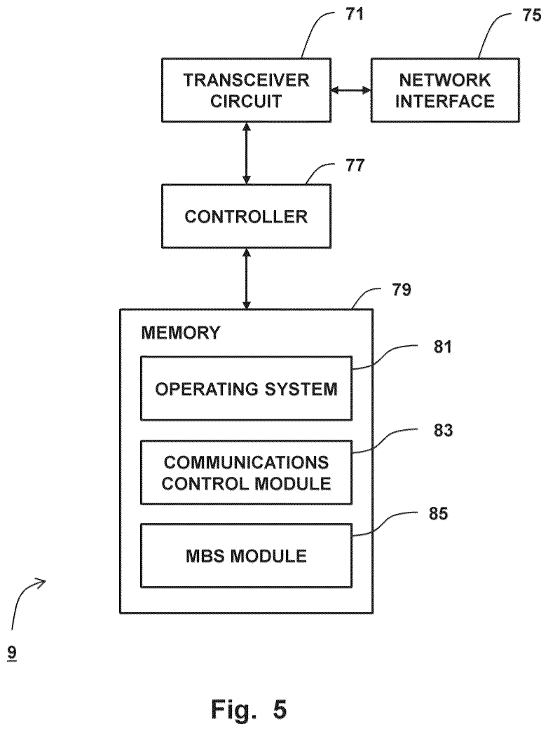

FIG. 5 is a block diagram illustrating the main components of a core network node shown in FIG. 1 (e.g. the AMF 9, the UPF 10, or the SMF 11). As shown, the core network node includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the base station 5 or other (R)AN nodes, as appropriate. The network interface 75 typically includes an appropriate base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an MBS module 85 (optional).

The communications control module 83 is responsible for handling (generating/sending/receiving) signalling between the core network node and other nodes, such as the UE 3, (R)AN nodes, and other core network nodes.

If present, e.g. in an MB-SMF or MB-UPF, the MBS module 85 is responsible for handling signalling relating to multimedia broadcast services. The signalling may comprise signalling relating to MBS (control signalling and/or data traffic).

### DETAILED DESCRIPTION

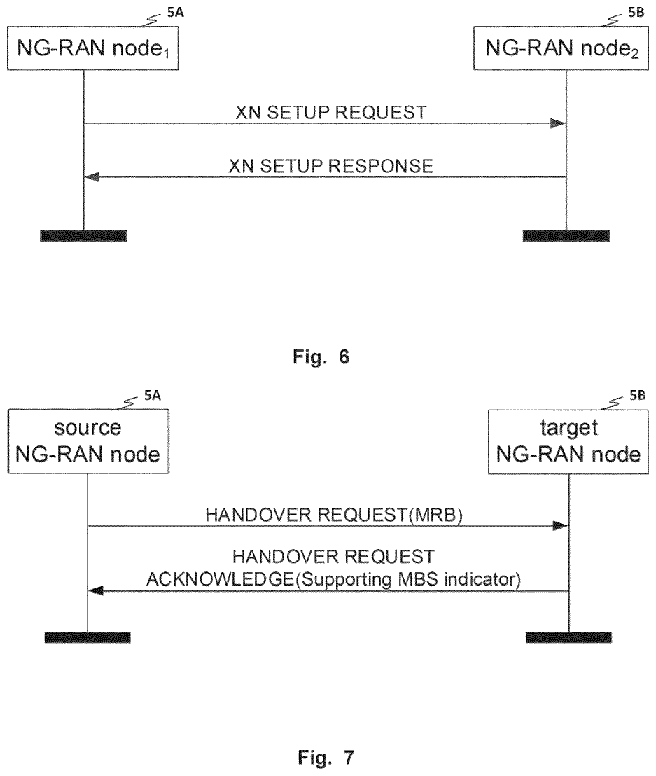

The following is a description of some exemplary procedures performed by the nodes of the system shown in FIGS. 1 and 2, with reference to FIGS. 6 to 11.

When the UE 3 joins an MBS session, a shared user plane tunnel is established for that session between the serving base station 5 and a user plane function 10 in the core network 7 for delivery of associated MBS traffic. The base station 5 can decide whether to use a point-to-point (PTP) or a point-to-multipoint (PTM) tunnel/bearer. A shared user plane tunnel (NG-U/F1-U tunnel) is used for PTM. In addition, a multicast radio bearer (MRB) is used for the MBS session. An MRB may be provided on a PTP leg, a PTM leg, or both. It will be appreciated that a shared user plane tunnel may be configured for a PTP leg as well, if appropriate.

In any case, it is assumed that the source base station 5 is aware of the MBS support of the target base station 5 before handover. Beneficially, the base stations 5 are configured to avoid full configuration at the new base station 5 (when the source and target base stations have different MBS support capabilities). Specifically, the so-called full configuration involves re-establishing the Packet Data Convergence Protocol (PDCP) entity at the new base station 5 in which case it is very likely that data loss will occur. Thus, in order to avoid full configuration during handover, the base stations 5 ensure that there is only one PDCP entity during the handover. The idea of a non-full configuration is to keep the PDCP entity of the source base stations 5, regardless whether this PDCP entity is from a DRB/multicast MRB/unicast MRB, and convert it to a suitable DRB (or MRB) for the target base stations 5.

### MBS Support Notification (Via Xn Setup)

FIG. 6 is a schematic signalling (timing) diagram illustrating an exemplary Xn setup procedure to which the present invention may be applicable. In this example, the setup procedure (or a similar update procedure) is used to exchange MBS support information between base stations 5. The MBS information may be included in at least one of the request and the corresponding response. It will be appreciated that MBS information may be provided on a per base station basis. A base station 5 may indicate its own MBS support related information using a suitable message, including but not limited to: an ‘XN Setup Request’ message (based on clause 9.1.3.1 of 3GPP TS 38.423, current version 16.7.0), an ‘XN Setup Response’ message (based on clause 9.1.3.2 of 3GPP TS 38.423), and an ‘NG-RAN node Configuration Update’ message (based on clause 8.4.2 of 3GPP TS 38.423).

The message may include an appropriately formatted ‘MBS supported’ information element (and/or the like) to indicate whether the base station that sent the message supports MBS. The message may include one or more information element to identify any supported MBS service or session (by their respective MBS session identifier/Temporary Mobile Group Identity (TMGI)), the supported delivery mode(s), and the supported service area(s), as shown below.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN | M | | 9.2.2.3 | | YES | reject |
| Node ID | | | | | | |
| MBS supported | O | | ENUMERATED | | YES | ignore |
| | | | (true, false, . . . ) | | | |
| > MBS session ID | | | | | | |
| list (TMGI) | | | | | | |
| > Delivery mode | | | ENUMERATED | | | |
| | | | (multicast, | | | |
| | | | unicast, . . . ) | | | |
| > MBS service | | | | | | |
| area(cell ID list) | | | | | | |
| TAI Support List | M | | 9.2.3.20 | List of | YES | Reject |
| | | | | supported TAs | | |
| | | | | and associated | | |
| | | | | characteristics. | | |

It will also be appreciated that MBS information may be provided on a per cell basis. In this case, the MBS information for each cell (at least one cell) may be included in an appropriately formatted information element, such as a ‘Served Cell Information NR’ information element (included in at least one of the messages described above).

The Served Cell Information NR information element is based on clause 9.2.2.11 of 3GPP TS 38.423. However, the information element is adapted to include cell specific MBS information as shown below.

| | | IE type and | | | Assigned |
|---|---|---|---|---|---|
| IE/Group Name | Presence | reference | Semantics description | Criticality | Criticality |
| NR-PCI | M | INTEGER | NR Physical Cell ID | — | |
| | | (0 . . . 1007, . . . ) | | | |
| NR CGI | M | 9.2.2.7 | | — | |
| TAC | M | 9.2.2.5 | Tracking Area Code | — | |
| RANAC | O | RAN Area Code | | — | |
| | | 9.2.2.6 | | | |
| . . . | . . . | . . . | . . . | . . . | . . . |
| MBS supported | O | ENUMERATED | | YES | ignore |
| | | (true, false, . . . ) | | | |
| >MBS session | | | | | |
| ID(TMGI) | | | | | |
| >Delivery mode | | ENUMERATED | | | |
| | | (multicast, | | | |
| | | unicast, . . . ) | | | |
| Configured TAC | O | 9.2.2.39a | NOTE: This IE is | YES | ignore |
| Indication | | | associated with the TAC | | |
| | | | on top-level of the Served | | |
| | | | Cell Information NR IE | | |
| NPN Broadcast | O | 9.2.2.71 | If this IE is included the | YES | reject |
| Information | | | content of the Broadcast | | |
| | | | PLMNs IE in the top | | |
| | | | Served Cell Information | | |
| | | | NR IE is ignored. | | |
| SSB Positions In | O | 9.2.2.64 | | YES | ignore |
| Burst | | | | | |
| NR Cell PRACH | O | OCTET STRING | Containing 9.3.1.139 NR | YES | ignore |
| Configuration | | | Cell PRACH | | |
| | | | Configuration as of TS | | |
| | | | 38.473 [41]. | | |

### MBS Support Notification (During Handover)

Alternatively, or in addition to Xn setup, the base stations 5 may be configured to exchange MBS support information with each other during a handover preparation procedure. For example, when the target base station supports any MBS session, delivery mode, or service area that has not been indicated previously, or that has changed, the relevant MBS information may be provided during handover.

FIG. 7 is a schematic signalling (timing) diagram illustrating an exemplary handover procedure to which the present invention may be applicable.

In this case, when initiating a handover procedure for a UE 3, the source base station 5A is configured to include the applicable MRB configuration in the ‘Handover Request’ message sent to the target base station 5B, for any MBS service used by the UE 3. If the target base station 5B can understand the MRB configuration, or in other words, it supports MBS, then the target base station 5B will provide its own MRB configuration/support indication in the response (i.e. in the ‘Handover Request Acknowledge’ message).

It will be appreciated that in this case the source base station 5A supports MBS, otherwise it may not have a capability (or need) to enquiry the target base station 5B. If the target base station 5B supports MBS, then the associated MBS information/configuration is included in the response (i.e. in the ‘Handover Request Acknowledge’ message).

### MBS Support Notification (Via ANR)

It will be appreciated that MBS support information for a given cell may be obtained from the UE 3, in an Automatic Neighbour Relation (ANR) procedure.

FIG. 8 is a schematic signalling (timing) diagram illustrating an exemplary ANR procedure to which the present invention may be applicable.

As can be seen, in step 3, the UE 3 reports, to its serving cell (Cell A), information relating to a neighbour cell (Cell B). In this case, however, the information reported by the UE 3 includes information relating to MBS support in the neighbour cell. In more detail, the UE 3 may transmit the following information to the serving base station 5A regarding the cell (Cell B) of the neighbour base station 5B: MBS support (e.g. true/false), which MBS services are supported, which delivery modes (e.g. multicast/unicast) are being supported (per service or cell). In this case, using the CGI-InfoNR information element as an example, MBS related information of a neighbour cell may be reported by the UE 3 as follows:

```
CGI-InfoNR ::=  SEQUENCE {
  plmn-IdentityInfoList  PLMN-IdentityInfoList  OPTIONAL,
  frequencyBandList  MultiFrequencyBandListNR  OPTIONAL,
  noSIB1 SEQUENCE {
    ssb-SubcarrierOffset  INTEGER (0..15),
    pdcch-ConfigSIB1 PDCCH-ConfigSTB1
  }  OPTIONAL,
  ...,
  [[
  npn-IdentityInfoList-r16  NPN-IdentityInfoList-r16 OPTIONAL
  ]],
  [[
  cellReservedForOtherUse-r16 ENUMERATED {true} OPTIONAL
  ]]
  [[
  MBSSupported-r16  ENUMERATED {true,false} OPTIONAL
    MESSessionlist ::= SEQUENCE (SIZE (1..maxMBSSession) ) OF
      MBSSessionInfo
  MBSSessionID ::=  SEQUENCE {
  TMGI
  MBSMode  (multicast, unicast, both)
  }
  ]]
}
```

### Lossless Handover

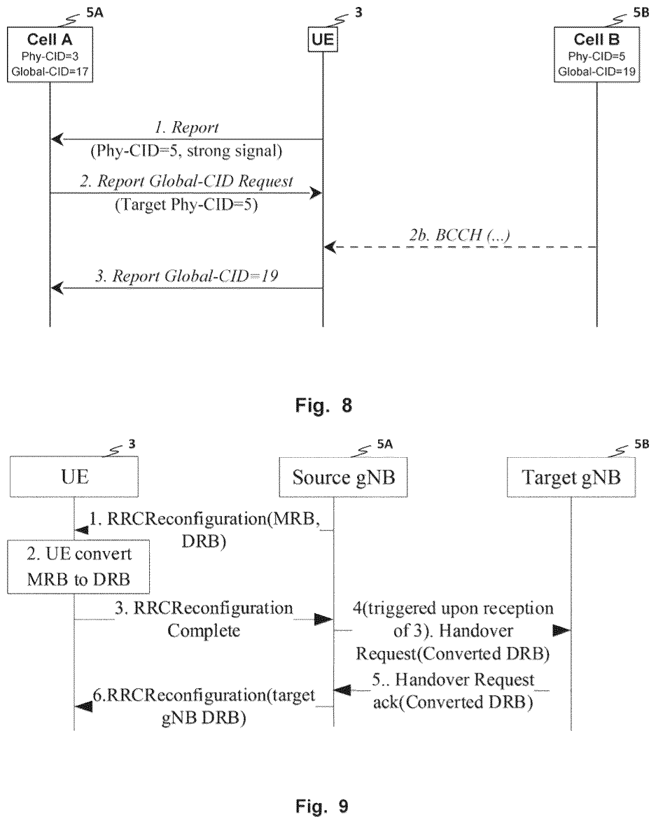

FIG. 9 is a schematic signalling (timing) diagram illustrating an exemplary handover procedure to which the present invention may be applicable. In this case, the source base station 5A is configured to convert the MRB configuration used by the UE 3 in the cell of the source base station 5A to an appropriate DRB. The source base station 5A reconfigures the MRB to a DRB at the UE 3 by sending an appropriately formatted RRCReconfiguration message to the UE 3 before initiating/executing the handover towards the target base station 5B.

The following is a description of the steps of this procedure, with reference to FIG. 9:

Step 1: In this example, the source base station 5A supports MBS via MRB (multicast) and the target base station 5B supports DRB only (unicast). After making a handover decision, but before sending a Handover Request to the target base station 5B, the source base station 5A sends an RRCReconfiguration message to the UE 3. The message includes at least one of: an MRB identifier (MRB ID) and a corresponding DRB identifier (DRB ID); and an MRB configuration (per MRB ID) and a corresponding DRB configuration. Effectively, this information represents a mapping of the applicable MRB and DRB configuration(s) for the MBS service(s) used by the UE 3 and it assists the UE 3 to switch between MRB and DRB in preparation for handover to the target cell.

Step 2: The UE 3 converts the MRB(s) to corresponding DRB(s) in accordance with the configuration received from the source base station 5A.

Step 3: The UE 3 generates and transmits an appropriate response (an ‘RRCReconfiguration Complete’ message) to the source base station 5A. It will be appreciated that step 4 is not triggered until the RRCReconfiguration Complete message is received by the source base station 5A.

Steps 4 and 5: Handover procedure between the source base station 5A and target base station 5B. As can be seen, the source base station 5A requests handover based on the converted DRB (instead of the MRB since the target base station 5B does not support MBS/MBS over MRB).

Step 6: The source base station 5A sends another RRCReconfiguration message to the UE 3, including the DRB configuration for the target base station 5B, to be used by the UE 3 after handover to the cell of the target base station 5B.

It will be appreciated that a mapping between the (old) MRB and the (new) DRB may be provided using an appropriate mapping table, as shown below. The mapping table (or information corresponding to the mapping table) may be included in the RRCReconfiguration message (step 1 of FIG. 9).

| | MRB ID | MRB configuration | DRB ID | DRB configuration |
|---|---|---|---|---|
| Entry 1 | 1 | . . . | 1 | . . . |
| Entry 2 | 2 | . . . | 2 | . . . |
| Entry 3 | 3 | . . . | 3 | . . . |

In a modification of the above procedure, the source base station 5A may be configured to convert the MRB(s) to DRB(s), and to send information indicating the appropriate DRB configuration(s) to the target base station 5B (instead of sending it to the UE 3) in an appropriately formatted Handover Request message. After the target base station 5B has accepted the DRB(s) and indicated its own DRB configuration(s) (by sending an appropriate Handover Request Acknowledge message), the source base station 5A proceeds to send an RRCReconfiguration message to the UE 3. The RRCReconfiguration message includes information identifying the mapping between the old MRB configuration(s) and the associated new DRB configuration(s) from the target base station 5B.

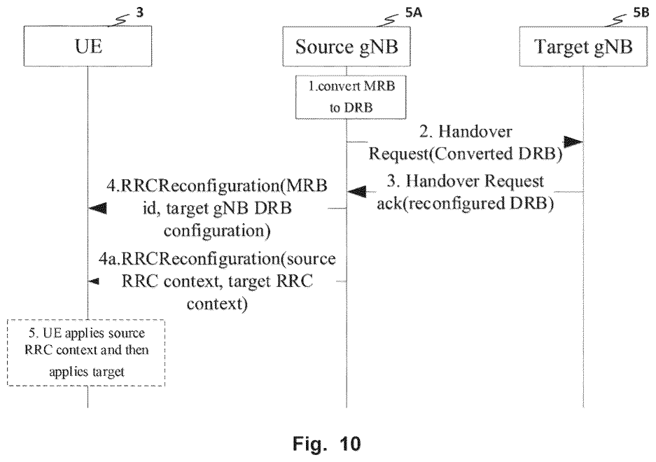

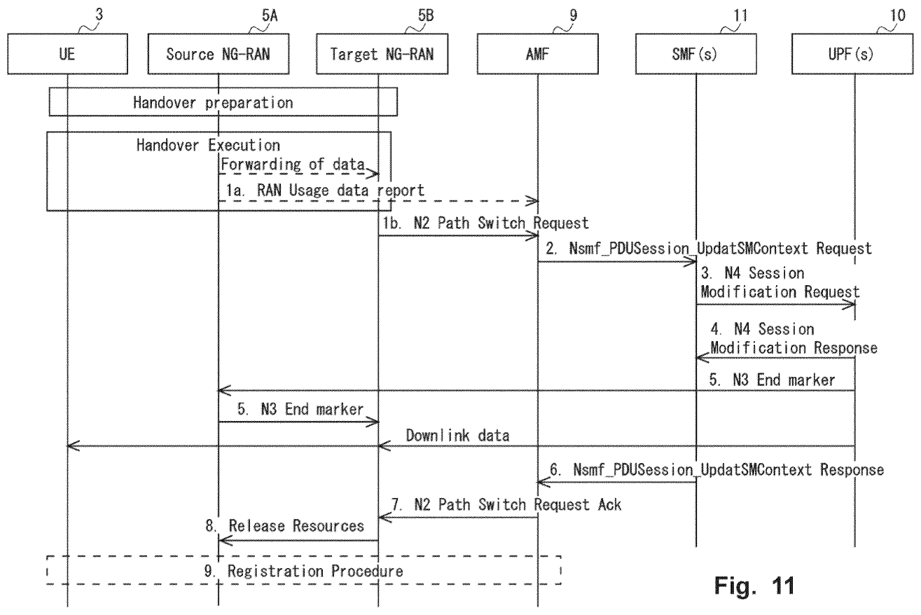

This alternative is illustrated in FIG. 10, in which:

Step 1: The source base station 5A converts the MRB(s) used by the UE 3 to DRB(s).

Steps 2, 3: The source base station 5A initiates a handover towards the target base station 5B using the converted DRB(s) and receives information identifying the corresponding DRB configuration(s) applicable at the target base station 5B. The information may be provided in the form of an RRC context (or RRC configuration) to be applied by the UE 3, or the source base station 5A on behalf of the UE 3. The target base station 5B may include this information in an appropriate information element of the Handover Request Acknowledge message, such as a ‘Target NG-RAN node To Source NG-RAN node Transparent Container’ and/or the like.

Step 4: If the source base station 5A can decode the information received from the target base station 5B, it proceeds to generating and sending an appropriately formatted RRCReconfiguration message to the UE 3 (by applying the received RRC context). Effectively, this message configures the UE 3 to convert its MRB(s) to appropriate DRB(s) based on the information received from the target base station 5B (MRB ID(s), target gNB DRB configuration(s) per MBS service).

Steps 4a and 5 (alternative to step 4): If the source base station 5A cannot decode the information received from the target base station 5B, it generates and sends an RRCReconfiguration message to the UE 3 including information associated with the source RRC context and the target RRC context. The source RRC context includes the converted DRB(s) associated to respective MRB(s), and the target RRC context includes the applicable RRC configuration for the target base station 5B for the respective DRB(s) to be used at the target base station 5B. The UE 3 is configured to apply the source RRC context first then to apply the target RRC context. Effectively, the UE 3 is configured to use a first DRB at the source base station 5A (instead of the MRB) based on the source RRC context and then switch to a second DRB at the target base station 5B to continue receiving the MBS service after handover based on the target RRC context.

Handover from a Non-Supporting Node to a Supporting Node

FIG. 11 is a schematic signalling (timing) diagram illustrating an exemplary (Xn based) inter NG-RAN handover procedure to which the present invention may be applicable. In particular, the ‘N2 Path Switch Request’ (in step 1b) may be adapted to include information regarding the MBS services supported by the target base station 5B. The information may be included in an ‘MBS service supported list’ field (or similar), and it may also identify MBS service areas (at least one) and the MBS session IDs (at least one) associated with the supported MBS services.

In more detail, some multicast services may be localised services that are available only in specific MBS service areas. Such MBS service areas are typically defined as a list of cells or frequencies. Thus, a particular MBS service (or session) may be provided via unicast in some areas (e.g. in the cell of the UE's current base station 5A) and the same MBS service may be provided via multicast cast in other areas (e.g. in the cell of the target base station 5B). It will be appreciated that, in some cells, a particular MBS service may be provided via both unicast and multicast (e.g. depending on the number of users). Also, there might be cells in which a particular MBS service is not provided, or where no MBS service is provided at all. It will be appreciated that a particular MBS service may be represented by either ‘MBS session’ or ‘TMGI’ or both.

The Path Switch Request message includes MBS session information relating to the MBS service(s) supported by the target node 5B (e.g. as a list of MBS session IDs). The MBS session information (at least one MBS session ID/TMGI) is provided with MBS service area level granularity. Based on the MBS session ID(s)/TMGI(s) and associated MBS service area(s), the AMF 9 is able to make a decision, for each MBS service supported by the target node 5B, whether to establish a shared MBS session or a dedicated MBS session in the cell of the target node 5B.

Specifically, if the information included in the Path Switch Request message indicates that the target cell supports a particular MBS service for multicast in the MBS service area of the target cell, then the AMF 9 proceeds to establish a shared MBS session for the UE 3 in that cell (or to reuse an existing shared MBS session).

If the target cell does not support a particular MBS service for multicast (in the MBS service area of the target cell), or if the information indicates that the target cell supports that MBS service by unicast, then the AMF 9 proceeds to establish a new unicast MBS session for the UE 3 in that cell, for that MBS service.

Further details of the relevant signalling messages and information elements are given below:
Path Switch Request (based on clause 9.2.3.8 of 3GPP TS 38.413)

This message is sent by the NG-RAN node 5 to inform the AMF 9 of the new serving NG-RAN node 5 and to transfer some NG-U DL tunnel termination point(s) to the SMF 11 via the AMF 9 for one or multiple PDU session resources.

Direction: NG-RAN node 5 to AMF 9

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| RAN UE NGAP ID | M | | 9.3.3.2 | | YES | reject |
| Source AMF UE NGAP ID | M | | AMF UE NGAP | | YES | reject |
| | | | ID 9.3.3.1 | | | |
| > MBS service supported list | | | | | | |
| >> MBS service area | | | | | | |
| >> MBS session information | | | | | | |
| list | | | | | | |
| User Location Information | M | | 9.3.1.16 | | YES | ignore |
| UE Security Capabilities | M | | 9.3.1.86 | | YES | ignore |

In this case, the ‘MBS service supported list’ field includes information regarding the MBS services supported by the target base station 5B, such as a list of (at least one) MBS service areas and information relating to at least one MBS session corresponding to a supported MBS service (‘MBS session information list’ field in this example). Each MBS session information may be represented by an associated TMGI and/or MBS session ID.
Path Switch Request Acknowledge (based on clause 9.2.3.9 of 3GPP TS 38.413)

This message is sent by the AMF 9 to inform the (target) NG-RAN node 5 that the path switch has been successfully completed in the core network 7.

Direction: AMF 9 to NG-RAN node 5

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| RAN UE NGAP ID | M | | 9.3.3.2 | | YES | reject |
| Source AMF UE NGAP ID | M | | AMF UE NGAP | | YES | reject |
| | | | ID 9.3.3.1 | | | |
| User Location Information | M | | 9.3.1.16 | | YES | ignore |
| UE Security Capabilities | M | | 9.3.1.86 | | YES | ignore |

In this case, the ‘Source AMF UE NGAP ID’ field includes information (e.g. ‘UE NGAP ID’) identifying an existing shared multicast NG GTP tunnel to be used for the MBS session at the target base station 5B.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP TS 38.300 V16.7.0 and 3GPP TS 37.340 V16.7.0 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the functionality of a gNB (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

Although not shown in FIG. 4, when the base station comprises a distributed gNB or en-gNB, the network interface also includes an E1 interface and an F1 interface (F1-C for control plane and F1-U for user plane) to communicate signals between respective functions of the distributed gNB or en-gNB. In this case, the software also includes at least one of: a gNB-CU-CP module, a gNB-CU-UP module, and a gNB-DU module. If present, the gNB-CU-CP module hosts the RRC layer and the control plane part of the PDCP layer of the distributed gNB or en-gNB. If present, the gNB-CU-UP module hosts the user plane part of the PDCP and the SDAP layers of the distributed gNB or the user plane part of the PDCP layer of the distributed en-gNB. If present, the gNB-DU module hosts the RLC, MAC, and PHY layers of the distributed gNB or en-gNB.

It will be understood by a person skilled in the art that the central unit may be implemented and physically located with the base station or may be implemented at a remote location, as a single physical element or as a cloud-based or virtualised system. It will also be understood that a single central unit may serve multiple base stations.

It will be appreciated that the above embodiments may be applied to 5G New Radio and LTE systems (E-UTRAN), and any future generation systems. A base station that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

In the above description, the UE, the access network node, and the data network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node, and the data network node as a signal over a computer network, or on a recording medium. Further, the functionality performed by part or all of this software may be performed using one or more dedicated hardware circuits. However, the use of software modules is preferred as it facilitates the updating of the UE, the access network node, and the data network node in order to update their functionalities.

The above embodiments are also applicable to ‘non-mobile’ or generally stationary user equipment. The above-described mobile device (UE) may comprise an MTC/IoT device, a power saving UE, and/or the like.

The first access network node may receive the MBS support information from the second access network node (e.g. in an ‘Xn Setup Request’, a ‘Handover Request’, an ‘Xn Setup Response’, or a ‘Handover Request Acknowledge’ message from the second access network node) or a user equipment (e.g. in a message forming part of an ANR procedure). The MBS support information may indicate that the second access network node supports MBS using a multicast mode or a unicast mode or both. The MBS support information may be included in a ‘CGI-InfoNR’ information element.

The MBS support information may include at least one of: information indicating whether the second access network node supports MBS (e.g. true/false); information identifying at least one MBS service supported by the second access network node; and information identifying an MBS mode supported by the second access network node (e.g. multicast, unicast, both).

The MBS support information may indicate whether a particular cell of the second access network node supports MBS (e.g. using a ‘Served Cell Information NR’ information element included in an ‘Xn Setup Request’/‘Xn Setup Response’ or using a ‘CGI-InfoNR’ information element in an ANR procedure).

The reconfiguring the UE may include sending a Radio Resource Control (RRC) message to the UE (e.g. a ‘RRCReconfiguration’ message). The RRC message may indicate a mapping between the MRB and the first DRB. The RRC message may include at least one of: an MRB identifier for the MRB and a corresponding DRB identifier; an MRB identifier for the MRB and a corresponding DRB configuration for the first DRB; and an MRB configuration for the MRB and a corresponding DRB configuration for the first DRB.

The method performed by the first access network node may further comprise reconfiguring the UE to use the first DRB for the MBS service, before initiating the procedure for handover of the UE to the second access network node, wherein after handover the MBS service may be provided to the UE over the second DRB.

The method performed by the first access network node may further comprise initiating the procedure for handover of the UE to the second access network node after receiving a confirmation from the UE that the reconfiguration is complete.

The method performed by the first access network node may further comprise reconfiguring the UE to use the first DRB for the MBS service, after initiating the procedure for handover of the UE to the second access network node, wherein after handover the MBS service may be provided to the UE over the second DRB.

The reconfiguring may comprise reconfiguring the UE to apply a first RRC context associated with the first access network node and the procedure for handover comprises reconfiguring the UE to apply a second RRC context associated with the second access network node. The first RRC context may be adapted to reconfigure the UE to use the first DRB for the MBS service, and the second RRC context may be adapted to reconfigure the UE to change from the first DRB to the second DRB.

The method may further comprise receiving the second RRC context from the second access network node and reconfiguring the UE to apply the first RRC context upon receipt of the second RRC context.

The method may further comprise reconfiguring the UE to use the DRB at the second access network node upon receiving an RRC context from the second access network node.

In a case that the first MBS service is not supported in the associated MBS service area by the first access network node acting as a target node for handover, the message transmitted by the network node may be adapted to include information for providing the first MBS service to the UE, via the first access network node, using an individual MBS traffic delivery method.

The information for providing the first MBS service using the shared MBS traffic delivery method may comprise information identifying a multicast tunnel associated with the first MBS session.

The information identifying the at least one MBS service supported by the access network node may comprise a respective MBS session identifier or Temporary Mobile Group Identity (TMGI) for each supported MBS service.

The information identifying the at least one MBS service supported by the access network node may comprise information identifying a respective service area for each supported MBS service.

The request for switching the path may form part of an Xn based inter NG-RAN handover procedure (e.g. the request may be an ‘N2 Path Switch Request’). The network node for handling connection and mobility management may comprise an Access and Mobility Management Function (AMF).

Various other modifications will be apparent to those skilled in the art and will not be described in further detail here.

This application is based upon and claims the benefit of priority from United Kingdom Patent Application No. 2119032.7, filed on Dec. 24, 2021, the disclosure of which is incorporated herein in its entirety by reference.

### REFERENCE SIGNS LIST

3 UE
5 base station
7 core network
9 AMF
10 UPF
11 SMF

What is claimed is:

1-36. (canceled)

37. A method performed by an access network node, the method comprising:
transmitting, to a further access network node, a handover request message including Multicast and Broadcast Services (MBS) session configuration information;
receiving, from the further access network node, a handover request acknowledgement message, wherein in a case where the further access network node or a cell of the further access network node supports MBS, the handover request acknowledgement message includes information indicating that the further access network node or the cell of the further access network node supports the MBS; and
controlling handover related to the MBS between the access network node and the further access network node based on the information.

38. The method according to claim 37, wherein
the information includes MBS session related information.

39. The method according to claim 37, wherein
the information includes information identifying a service of the MBS supported by the further access network node or the cell of the further access network node.

40. The method according to claim 37, further comprising:
in a case where the further access network node does not support the MBS over a multicast radio bearer (MRB):
receiving, from the further access network node, configuration for a second data radio bearer (DRB) at the further access network node; and
transmitting, to a user equipment (UE), the configuration for the second DRB for providing the MBS to the UE over the second DRB.

41. The method according to claim 40, further comprising:
transmitting, to the UE, configuration for a first DRB at the access network node before transmitting the handover request message, wherein
the handover request message includes a configuration for the first DRB.

42. The method according to claim 40, wherein
the configuration for the second DRB is included in a Radio Resource Control (RRC) message to the UE.

43. The method according to claim 42, wherein
the RRC message indicates a mapping between the MRB and the second DRB.

44. The method according to claim 41, wherein
the configuration for the first DRB is included in a Radio Resource Control (RRC) message to the UE.

45. The method according to claim 44, wherein
the RRC message indicates a mapping between the MRB and the first DRB.

46. The method according to claim 44, wherein
the RRC message includes at least one of:
an MRB identifier for the MRB and a corresponding DRB identifier;
an MRB identifier for the MRB and a corresponding DRB configuration for the first DRB or the second DRB; or
an MRB configuration for the MRB and a corresponding DRB configuration for the first DRB or the second DRB.

47. A method performed by a further access network node, the method comprising:
receiving, from an access network node, a handover request message including Multicast and Broadcast Services (MBS) session configuration information;
transmitting, to the access network node, a handover request acknowledgement message, wherein in a case where the further access network node or a cell of the further access network node supports MBS, the handover request acknowledgement message includes information indicating that the further access network node or the cell of the further access network node supports the MBS; and
controlling handover related to the MBS between the further access network node and the access network node based on the information.

48. A method performed by a user equipment (UE), the method comprising:
receiving a Multicast and Broadcast Services (MBS) service using a multicast radio bearer (MRB) via an access network node acting as a source node for a handover;
performing the handover from the access network node to a further access network node acting as a target node; and
receiving the MBS from the further access network node, in a case where the further access network node or a cell of the further access network node supports the MBS, and
wherein the handover between the further access network node and the access network node is controlled based on information indicating that the further access network node or the cell of the further access network node supports the MBS.

49. The method according to claim 48, further comprising:
receiving, from the access network node, configuration of a data radio bearer (DRB) at the further access network node, in a case where the further access network or the cell of the further access network node does not support the MBS over the MRB, and wherein
the performing the handover is performed by performing handover from the MRB to the DRB, and
the receiving the MBS is performed by receiving the MBS over the DRB.

50. An access network node comprising:
at least one memory storing instructions; and
at least one processor configured to process the instructions to:
transmit, to a further access network node, a handover request message including Multicast and Broadcast Services (MBS) session configuration information;
receive, from the further access network node, a handover request acknowledgement message, wherein in a case where the further access network node or a cell of the further access network node supports MBS, the handover request acknowledgement message includes information indicating that the further access network node or the cell of the further access network node supports the MBS; and
control handover related to the MBS between the access network node and the further access network node based on the information.

51. A further access network node comprising:
at least one memory storing instructions; and
at least one processor configured to process the instructions to:
receive, from an access network node, a handover request message including Multicast and Broadcast Services (MBS) session configuration information;
transmit, to the access network node, a handover request acknowledgement message, wherein in a case where the further access network node or a cell of the further access network node supports MBS, the handover request acknowledgement message includes information indicating that the further access network node or the cell of the further access network node supports the MBS; and
control handover related to the MBS between the further access network node and the access network node based on the information.

52. A user equipment (UE) comprising:
at least one memory storing instructions; and
at least one processor configured to process the instructions to:
receive a Multicast and Broadcast Services (MBS) service using a multicast radio bearer (MRB) via an access network node acting as a source node for a handover;
perform the handover from the access network node to a further access network node acting as a target node; and
receive the MBS from the further access network node, in a case where the further access network node or a cell of the further access network node supports the MBS, and
wherein the handover between the further access network node and the access network node is controlled based on information indicating that the further access network node or the cell of the further access network node supports the MBS.
